(19) United States
(12) Patent Application Publication
(10) Pub. No.: US 2026/0317974 A1
(43) Pub. Date: Oct. 15, 2026

(54) A process for dry-forming a fibrous raw material

(71) Applicant: Teknologian tutkimuskeskus VTT Oy, Espoo (FI)

(72) Inventors: Harri Kiiskinen, Espoo (FI); Elina Pääkkönen, Espoo (FI); Sara Paunonen, Espoo (FI); Titta Kiiskinen, Espoo (FI); Jussi Virkajärvi, Espoo (FI)

(21) Appl. No.: 19/483,623

(22) PCT Filed: May 30, 2024
(86) PCT No.: PCT/FI2024/050283

§ 371 Date: Nov. 12, 2025

(30) Foreign Application Priority Data
May 31, 2023 (FI) 20235613

(51) Int. Cl. D04H 1/732; B27N 3/04; D04H 1/26; D04H 1/425; D21H 23/50; D21H 25/06; D21H 27/10

(52) U.S. Cl. CPC D04H 1/732; B27N 3/04; D04H 1/26; D04H 1/425; D21H 23/50; D21H 25/06; D21H 27/10

(57) ABSTRACT

The present invention relates to a process for preparing a renewable fiber product web from a fibrous raw material, by utilizing dry-forming technology, whereby the bonding of the fibers takes place without adding large quantities of water, optionally while applying compression, causing the creation of fiber-fiber hydrogen bonds. The invention further relates to the thus formed fiber product.

### FIELD

The present invention relates to a process for dry-forming a fibrous raw material to form a fiber networks, and to the product thus obtained, as well as the uses of such products, particularly in insulation and cushioning materials.

### BACKGROUND

Commercial insulation and cushioning materials are typically made from expanded polystyrene (EPS), mineral or glass wool, and the fibers or other components of the webs are bonded together using chemicals, heat or mechanical actions. Said materials are, however, not renewable. In fact, the EPS that is still very common in such materials is fossil-based, and is soon to be banned from use in certain applications.

One technology that has been studied with the purpose of replacing these polymeric materials with renewable fibrous alternatives, is foam forming of natural fibrous raw-materials (see Hjelt et al. 2022). This technology has shown that it is possible to replace plastics with renewable alternatives when preparing fiber sheet products for applications such as thermal and acoustic insulation and cushioning materials. Also absorbing materials have utilized this technology.

Foam technology, however, uses considerable amounts of water, and thus requires the use of considerable amounts of time and energy for drying the product. First, most of the water used for foam-forming needs to be evaporated, whereby thermal drying can begin at 10-30% dry solids content. Existing dry-forming solutions on the other hand utilize synthetic binding agents that again decrease the content of renewable agents in the formed products (see WO 2006107847 A1).

Thus, there is a need for new, energy-efficient dry-forming techniques that can be carried out without the use of synthetic binders.

### SUMMARY OF THE INVENTION

The invention is defined by the features of the independent claims. Some specific embodiments are defined in the dependent claims.

According to a first aspect of the present invention, there is provided a process for dry-forming a fibrous raw material to provide a fiber network, in a process that requires less water than foam-forming.

According to a second aspect of the present invention, the dry-forming is carried out using a gas assisted dry-forming step.

According to a third aspect of the invention, the dry-forming is carried out in a manner that achieves inter-fiber bonding without the use of separate binding agents.

According to a fourth aspect, there is provided a dry-formed fiber product web, possible to prepare even without separate synthetic or fossil-based binding agents.

According to a further aspect, there is provided the use of a dry-formed fiber product in preparing insulation or cushioning materials, particularly for thermal or acoustic insulation materials or for packaging, or in preparing filtering or absorbing materials.

The present invention thus relates to a process for preparing a renewable fiber product web from a fibrous raw material by utilizing gas-assisted dry-forming, whereby the bonding of the fibers takes place without using large amounts of water, optionally while applying compression, causing the creation of fiber-fiber hydrogen bonds. Further, the invention relates to the thus formed product.

Considerable advantages are achieved using the present invention, compared to prior forming techniques. Among others, the process of the invention, with the dry-forming step, uses radically less water (about 1/10) compared to foam technology, while still resulting in a porous product. The fibers are bonded by utilizing low moisture levels and thermal drying, and both the density level and the strength of the formed product can be adjusted by adjusting the drying conditions, such as the level of compression, and the initial moisture content of the material before drying. By moistening the web using a spray nozzle, an ultrasound-generated mist, saturated or superheated steam, an improved hydrogen bonding, i.e. increased bonding, can be achieved for the dry-formed structures, compared to a re-moistened foam-formed webs, as the moisture acts as a binder fluid and the mist can be more easily distributed in the web compared to larger droplets. This mist generation also has the further advantage of a low energy-consumption.

Further, as the process of the invention can be carried out without the use of separate synthetic or fossil-based binding agents, which typically are synthetic polymers, the invention further improves the sustainability of fiber products intended for the above uses. Thus, the new products can be fully biodegradable and recyclable.

### BRIEF DESCRIPTION OF THE DRAWINGS

FIG. 1 shows the compression strengths of air-laid, compressed and dried sheets of CTMP and BSKP fibers with foam-formed sheets used as comparative samples;

FIG. 2 shows the effect of the applied moisture on the strengths of the samples was also tested, in FIG. 2A for CTMP and in FIG. 2B for BSKP fluff;

FIG. 3 shows the recovery of the samples after compression;

FIG. 4 shows the amounts of evaporated water required for the production of the final sheets, for both the samples of the invention and the reference samples;

FIG. 5 shows differences in production capacity (FIG. 5A) and drying time (FIG. 5B);

FIG. 6 shows the thermal conductivity of the sample of the invention and a foam-laid reference sample;

FIG. 7 shows the thermal conductivities of air-laid fibre webs (at 50% and 66% moisture contents) and a foam-formed fibre web prepared from BSKP;

FIG. 8 shows the pore diameters of air-laid fibre webs and foam-formed fibre webs of BSKP and CTMP samples;

FIG. 9 shows x-ray microtomography images of air- and foam-laid webs of BSKP and CTMP samples, the top images showing cross-sectional slices, with the average pore diameter written in white numbers (μm), and the bottom images showing the x-ray tomography images, the samples having a density of 30 kg/m³ unless otherwise stated;

FIG. 10 shows fibre orientations of foam- and air-laid webs of BSKP and CTMP samples, with a density 30 kg/m³ unless otherwise stated;

FIG. 11 shows the results of the tests used to determine the strength of samples of air-laid fluff fibre webs prepared by moistening by misting, steaming or spraying, with the tensile index shown in FIG. 11A, and the tensile stiffness index shown in FIG. 11B

FIG. 12 is a graphical comparison of the strength (as the tensile index) vs the density of air-laid fluff fibre webs prepared by moistening by misting, steaming or spraying.

### EMBODIMENTS

### Definitions

In the present context, the term “renewable fiber” refers to a fiber material obtained from a source that can be replenished over time. Different forms of biomass are preferred sources of renewable fibers.

The term “foam-forming” describes a previously utilized strategy for preparing renewable fiber sheet products, as the foam facilitates the required binding of the fibers, which in more conventional products, such as nonwovens, would be achieved using non-renewable binding agents.

“Dry-forming” is a technique that has been tested in the manufacture of paper and board products, and utilizes dry compression to replace conventional pulp moulding techniques, and reduce consumption of water and energy. The dry-forming is carried out using considerably smaller moisture levels as compared to conventional techniques (e.g. foam forming). “Gas-assisted dry-forming” is a technique that can be used as the step preceding the compression step, e.g. to provide an uncompressed, and therefore porous, fibrous web having a suitable solids content, and being suitable for being shaped into a sheet having the desired thickness and density, e.g. by compression. The gas used in the technique can be air, or according to another option an air-mist mixture, whereby an air-laid product is obtained, or another gas, or steam, can be used, or a combination of more than one of these.

The present invention relates to a process for preparing a renewable fiber product from a fibrous raw material, by
depositing a fibrous raw material comprising a renewable fiber material in a content of 95-100 w-%, calculated from the solids of the raw material, into a fiber web using gas-assisted dry-forming,
moistening the raw material to a selected moisture content in the range of 10-70%, before, during or after the dry-forming, to form a moistened fiber web, and drying the moistened fiber web to form a dry-formed fiber product.

Typically, the moisture content is selected based on the target strength of the formed fiber product. The target strength is, in turn, typically selected to a level of >1.5 Nm/g (tensile index), preferably >4 Nm/g, and most suitably 4-14 Nm/g. For compression stress the typically selected level is >20 kPa, preferably 50-200 kPa, and the recovery after 50% compression is typically 79-86%. Thermal conductivity of an exemplary material is about 35 mW/mK while for foam-laid materials typical value is 37 mW/mK.

A preferred temperature to be used during the gas-assisted dry-forming is 20-105° C.

In an embodiment of the invention, the carrier fluid used in the gas-assisted dry-forming, which typically is air, will preferably contain also steam. In another option, described below, the carrier fluid may contain also mist. This embodiment will have the additional advantages of facilitating both the moistening of the fibrous material and the bonding of the fibers.

As mentioned above, the fibrous raw material of the invention comprises at least 95 w-% of a renewable fiber material. However, an even higher content of renewable fiber material can be utilized, such as a content of 98 w-%, or 100 w-%. Preferred renewable fibers are obtained from any biomass. However, particularly preferred fibers are cellulose fibers. These can be obtained from any softwood or hardwood species, or a mixture of those, or from non-wood plants or recycled fibers, or from man-made or synthetic fibers, preferably being obtained from dry wood pulps. Preferred softwood species include pine and spruce. Preferred hardwood species, in turn, include birch, eucalyptus and acacia. Preferred man-made fibers include lyocel and viscose. The raw material can also contain thermoplastic or thermoset polymers, such as polyethylene (PE) or polypropylene (PP), in contents of less than 5 w-% of the fiber raw material.

The fibers of the raw material used herein typically have a length weighted average fiber length (later referred as average fiber length) of <3.5 mm, preferably <3 mm, most suitably 0.5-3 mm, measured, for example, using an L&W FiberTester. However, also longer fibers can be added. Thus, at least 80 w-%, preferably at least 85 w-%, and most suitably at least 95 w-% of the fibrous raw material has said average fiber length of <3.5 mm, whereas the optionally added longer fibers may have an average fiber length of >5 mm.

As stated above, the present method can be carried out without the use of any separate binding agents. However, in an embodiment of the invention, small amounts of such binding agents such as starch or rosin compounds, Alkyl Ketene Dimer (AKD), Alkenyl Succinic Anhydride (ASA), polyamide-amine-epichlorohydrin (PAE), poly-(D)-glucosamine or poly(vinyl alcohol) (PVOH), or binding fibers, can be added to facilitate the moisture-induced hydrogen bonding of the fibers. Typically, the optional binders are added during the forming phase or applied on the formed mat as a spray or a foam, into a content of less than 5 wt-%. Also water-binder mixtures can be added as mist during the forming, or applied on a formed mat utilizing an ultrasound atomizer.

The invention is, however, based on the formation of hydrogen bonds between the fibers, and this is achieved using the above moisture content in the range of 10-70%. Preferably, the moisture content is 30-70%, as moisture contents reaching levels below 30% will begin to cause reduced level of hydrogen bonding. However, by selecting the moistening technique to misting or steaming, particularly misting, also lower moisture contents of 10-40%, particularly 15-30%, are preferred, as they will cause the desired hydrogen bonding.

The moistening step of the method of the invention can be carried out at any step before, during or after the fiber deposition step. Preferably, the moistening, however, takes place after the fiber deposition step, whereby the moistening step is separate from the dry-forming.

In an embodiment, the moistening takes place by spraying, or by misting or steaming, preferably using a fine aerosol. Particularly, an ultrasound-generated mist or steam can used for moistening the web, thereby providing increased bonding in the dry-formed structures. Most suitably, a mist is used. The intensity and frequency of the ultrasound atomizer used for mist generation can be adjusted to produce a suitable droplet size, for different types of the fibre structures, in the range of 0.1-500 μm, preferably 1-50 μm. Further, suction can be used to direct the formed mist through the fibre material.

The drying step that is used to provide the final product is carried out as a thermal drying, preferably at a temperature of up to 400° C., or up to 200° C., or a lower temperature, such as 70-140° C., and a pressure below 4 MPa, and more preferably by non-contact drying, air drying, microwave drying, radiofrequency drying, infrared drying, cylinder drying, or by using superheated steam, or by any combination of these, most suitably by through air drying (TAD) e.g. using air and superheated steam. Also impingement drying is a suitable alternative.

In an embodiment of the invention, the dry-formed web is compacted before or during the drying step, e.g. by prolonging the drying, or by compressing, until a desired density is achieved.

It is, however, preferred to maintain the possibility to control the porosity of dry-formed fiber product. The pore size is, in turn, typically smaller in air-laid products than in foam-formed products, with the dry-formed fibre products of the invention typically containing pores having an average pore diameter of <300 μm, preferably 100-280 μm, and most suitably 100-150 μm.

In one embodiment of the invention, the drying, and an optional separate compacting, is carried out to produce a fiber product having a density of 20-100 kg/m³, preferably 25-80 kg/m³, or 20-40 kg/m³, depending on the intended use, and most suitably 50-70 kg/m³. For packing materials, a slightly higher density is preferred, such as the particularly preferred range of 50-70 kg/m³, while a preferred density for e.g. insulating materials would be lower, e.g. 20-40 kg/m³. For filtering, the preferred density would be 40-70 kg/m³, or 150-300 kg/m³, depending of the type of the filtration. These density ranges will result in products resembling a conventional board product (e.g. 200-700 kg/m³), suitable for use in, among others, packaging and cushioning materials, or in insulating materials.

However, even densities as low as 10 kg/m³ can be achieved.

In a separate embodiment, the drying, and an optional separate compacting, is carried out to produce a fiber product having a density of 450-700 kg/m³, preferably 500-650 kg/m³. This will result in a product resembling a conventional paper product (i.e. coated or uncoated printing paper or special paper), suitable for a wide variety of applications.

In addition to the above described method, the present invention also relates to the dry-formed fiber product obtained using said method. Due to the use of this specific method, the obtained product will be formed of 95-100 w-% renewable fiber raw materials, preferably 100 w-%. The possible remaining content of less than 5 wt-%, calculated from the solid matter of the formed fiber raw material mixture, might include e.g. thermoplastic or thermoset polymer, such as polyethylene (PE) or polypropylene (PP).

This product can be used in a wide range of applications. Particularly, the product can be used in preparing insulation or cushioning materials, preferably for thermal or acoustic insulation materials or for packaging, or in preparing filtering or absorbing materials.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### EXAMPLES

### Example 1—Strength of Air-Laid Fiber Webs

Chemi-thermomechanical pulp (CTMP) and bleached Kraft softwood pulp (BKSP) fibers were air-laid and moistened with 10%, 20%, 30%, 40%, 50% and 66% water. The obtained sheets were compressed to thicknesses of 5 mm and 7.5 mm, and dried under compression at 70° C. Foam-formed CTMP and BKSP sheets were used as comparative samples.

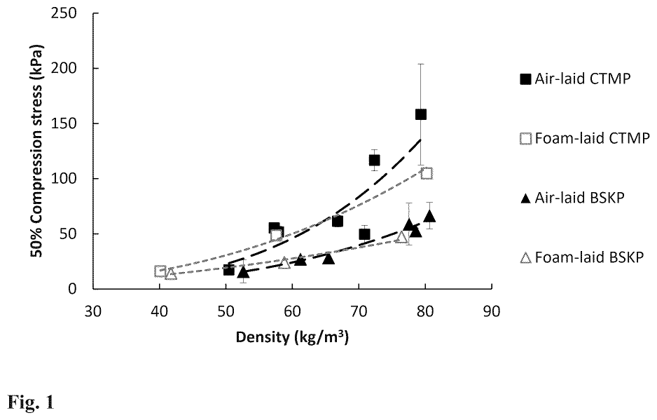

The compression strength of the obtained samples was measured, and the results shown in FIG. 1. As the results indicate, the compression strengths of the air-laid sheets was high, and well comparable with the strengths of the foam-formed comparative sheets.

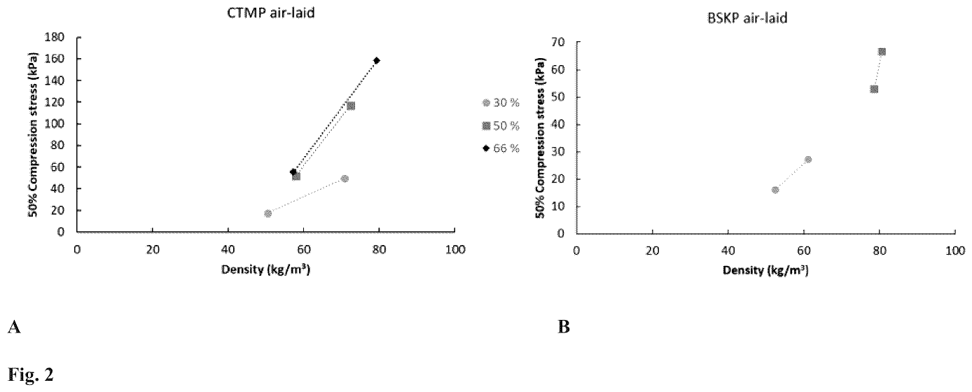

The effect of the applied moisture on the strengths of the samples was also tested, and the results shown in FIGS. 2A and 2B. As these results show, a 50% moisture level already gave a sufficiently high strength to the structure, with no need for further wetting. A low moisture was shown to have an impact by weakening the bonding, but also the low moisture levels gave a sufficient strength.

FIG. 3 shows the recovery after compression, with the samples of the invention providing a highly comparable, or even better recovery, compared to the foam formed samples.

### Example 2—Water Evaporated from Air-Laid Fiber Webs

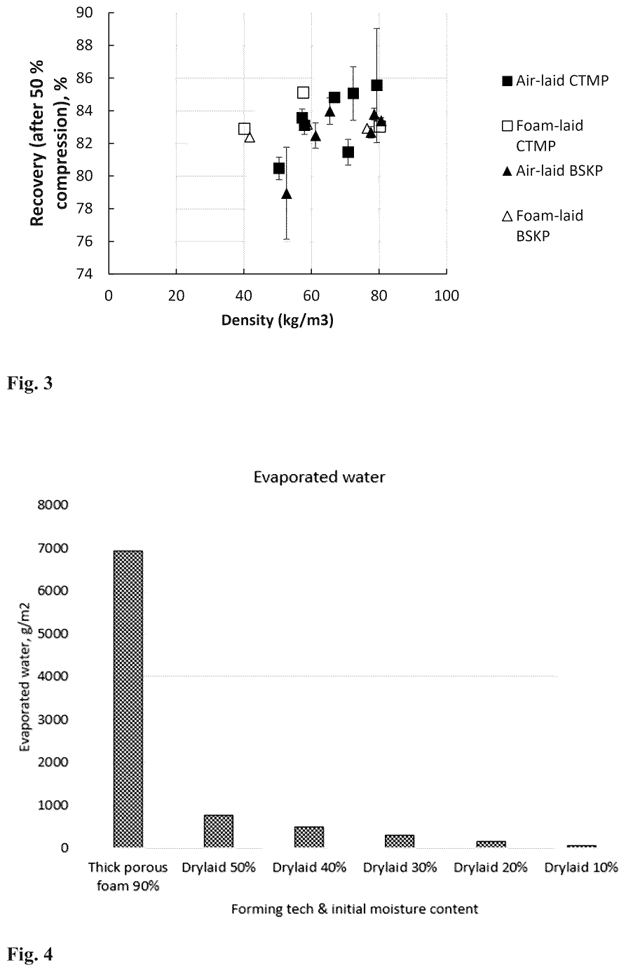

Air-laid samples were prepared as described in Example 1, using CTMP fibers. Foam-formed sheets were again used as reference samples. The amounts of evaporated water required for the production of the final sheets are compared in FIG. 4.

With the foam formed materials drying typically starts at c.a. 90% moisture content, whereby high amounts of water need to be evaporated before drying can even start.

With the air-laid materials, a re-moisturizing step can be used, and still the moisture content will be significantly lower than with the foam-formed samples, and significantly lower amounts of water need to be evaporated.

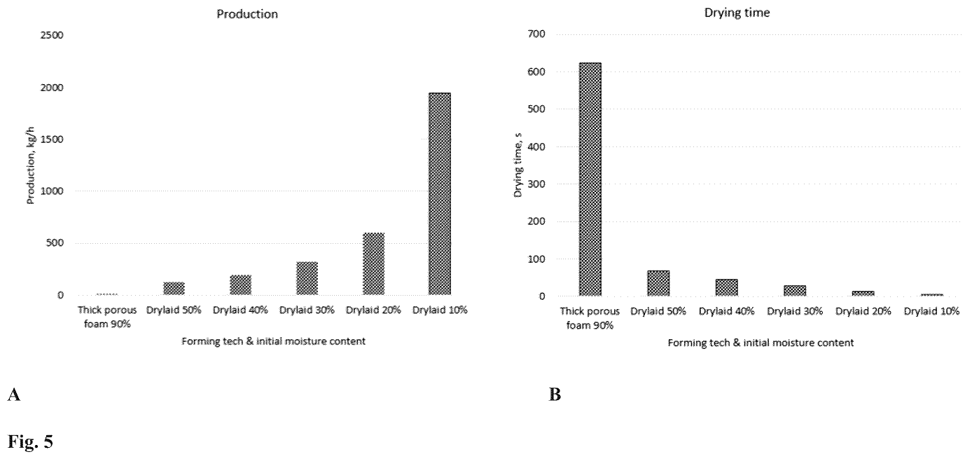

The radically lower amount of evaporated water, using the present invention, leads also to savings in drying costs, faster production, as well as smaller initial water consumption. Said differences in production capacity and drying time are shown in FIGS. 5A and 5B.

### Example 3—Thermal Conductivity of Air-Laid Webs

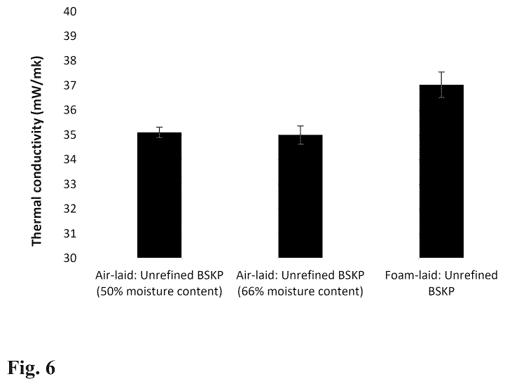

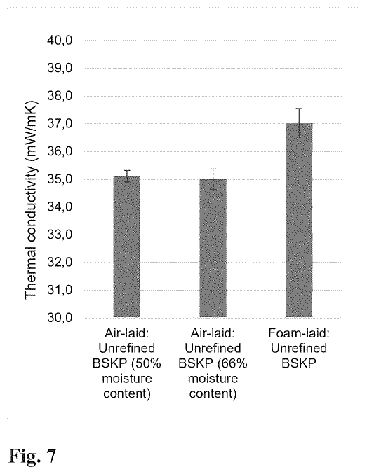

Tests were carried out on the air-laid materials prepared as described in Example 1. FIG. 6 demonstrates that lower thermal conductivity values are achieved with the air-laid materials than with foam-laid samples, as shown with materials having a density of 30 kg/m³ and a thickness of 30 mm. The thermal conductivities were measured by using Heat flow meter HFM Fox314 (ISO8301 standard).

### Example 4—Comparison of Air-Laid and Foam-Formed Samples

Chemi-thermomechanical pulp (CTMP) and bleached Kraft softwood pulp (BKSP) fibers were air-laid, moistened and compressed (into desired density) as shown in the below Table 1. Foam-formed CTMP and BKSP sheets were used as comparative samples. The density, thermal conductivity and average pore diameter for the samples were determined, and are shown in Table 1.

TABLE 1

| | | | | | Average |
|---|---|---|---|---|---|
| | Air or | | | Thermal | pore |
| Test | foam- | | Density | conductivity | diameter |
| point | laid | Material | (kg/m³) | (mW/mK) | (μm) |
| 41_2 | Air | BSKP 50% | 28.7 | 35.1 | 142 |
| | | moisture | | | |
| | | content | | | |
| 41_5 | Air | BSKP 66% | 28.8 | 35.0 | 137 |
| | | moisture | | | |
| | | content | | | |
| 42 | Air | BSKP | 39.8 | 34.5 | 107 |
| 45 | Air | CTMP | 26.9 | 37.1 | 265 |
| 1 | Foam | Unrefined | 29.3 | 37.0 | 364 |
| | | BSKP | | | |
| 11 | Foam | CTMP | 32.2 | 35.2 | 417 |

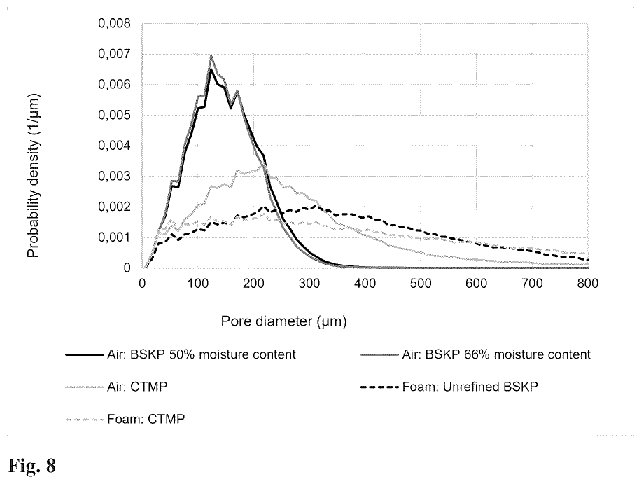

The results for the thermal conductivity for samples with a density of 30 kg/m³ are also shown in FIG. 7. It has been found that air-laid BSKP samples have lower thermal conductivity compared to foam-laid BSKP sample. On the other hand, air-laid CTMP has higher thermal conductivity compared to the foam-laid CTMP sample.

Further, it has been found that smaller pore size gives lower thermal conductivity in air-laid sheets. These pore sizes are shown in FIG. 8. As seen from the figure, both foam-laid samples (particularly the foam-laid BSKP sample) have a larger pore size than the air-laid sheets, and a significantly larger variation of the pore sizes.

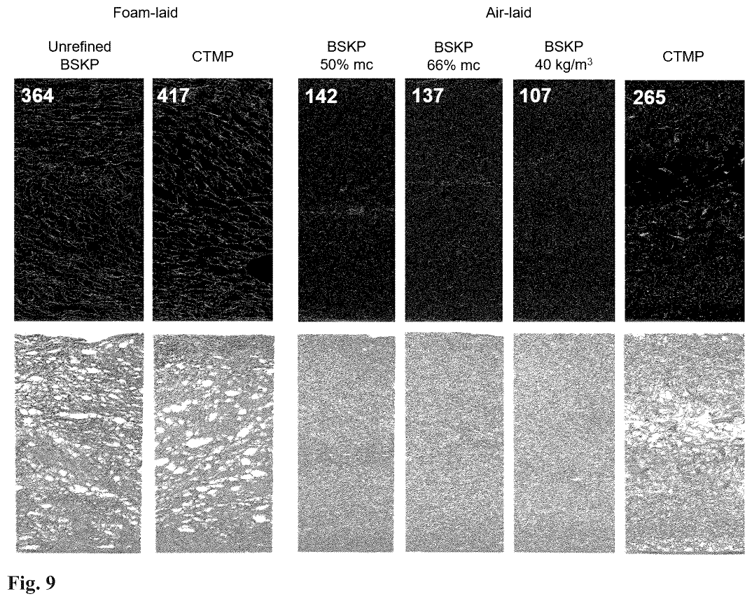

The effect of the pore sizes is visualized also in FIG. 9, which shows cross-sectional slices and visualizations of the x-ray microtomography images. The differences between pore sizes of foam- and air-laid samples can be seen visually. Air-laid CTMP sample has an uneven structure in the middle of the sample (z-direction) containing fibre clumps, which has been interpreted to affect the thermal conductivity of the sample, although as can be seen from FIG. 7A, this effect is not significant.

More importantly, the images show that the air-laying is effective in avoiding the formation of large pores in the products.

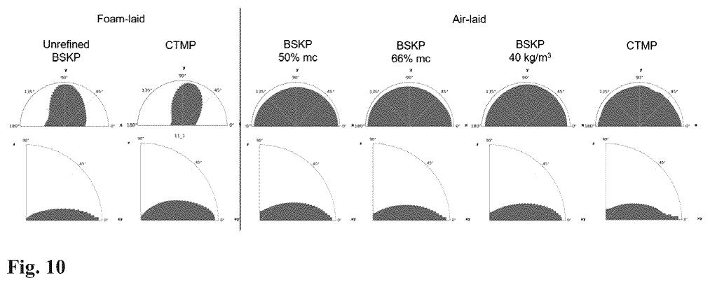

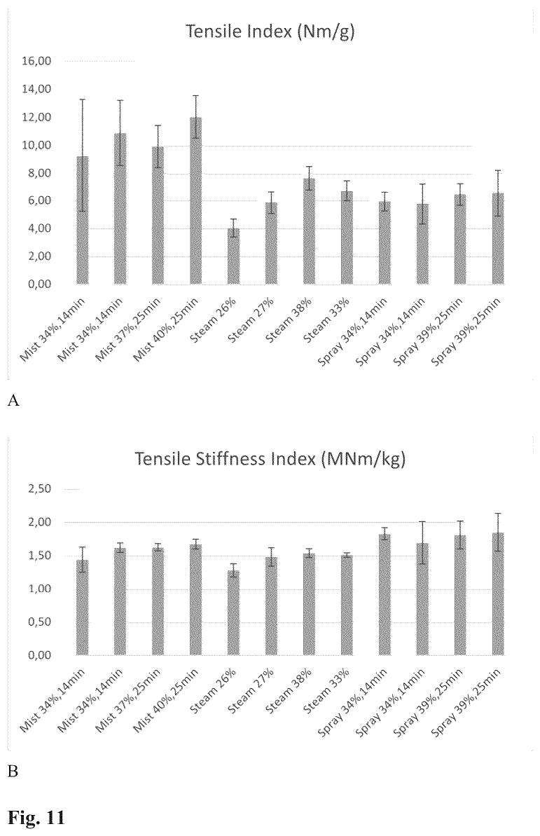

Finally, the fibre orientations are shown in FIG. 10. As the results indicate, in foam-laid samples the fibres are oriented on xy-plane to the direction of the foam flow in the mould. In air-laid samples the fibers are orientated equally to both x and y directions. This will also have a significant impact on the strength and thermal properties of the final product.

### Example 5—Air-Laying with Water Bonding Using Mist or Steam Vs Spray

Sample webs were prepared from fluff fibres by air-laying (the grammage aimed at 200 g/m²).

The fibres were bonded by moistening the web using three different water application methods, i.e. by using water droplets formed into a mist, a steam or a spray. The mist was generated by ultrasound in an air humidifier, the steam was generated by a steam cleaner, and the spray was generated by common spraying. Low-level vacuum was used to enhance the moisture penetration into the structure except with samples moistened with spray. Three different moisture levels (20%, 35% and 40% with optimum value 40% for eucalyptus) were aimed by adjusting application times. Two replicates were prepared for each sample. The webs were dried by heating, and compressed using a dynamic press: 7.33 bar (machine 90 bar), 60 s, upper plate 145° C., lower plate not heated. Reference samples were also prepared without moistening, and with only heat and compression.

Table 2 shows the amount of time required to moisten the different samples to the desired moisture levels.

TABLE 2

| Sample | Moisture content | Moisture application time |
|---|---|---|
| Misted samples | 19% | 5 min 30 s |
| | 34% | 14 min |
| | 38% | 25 min |
| Steamed samples | 19% | 1 min 12 s |
| | 26% | 2 min 42 s |
| | 35% | 4 min |
| Sprayed samples | 34% | 14 min |
| | 39% | 25 min |

Tissue tensile strength tests were carried out for the sample sheets after the sheets had been kept for several days in standard paper lab conditions, with the results for the tensile index shown in FIG. 11A, and the results for the tensile stiffness index shown in FIG. 11B.

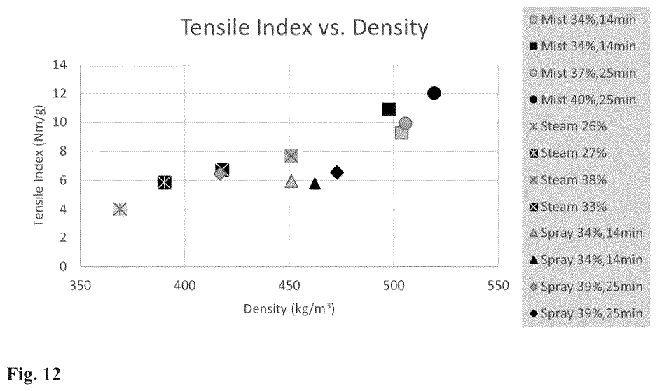

Further, FIG. 12 shows a comparison of the tensile index and the density.

As a conclusion, based on the tests of this Example, it was found that:
the mist produces denser samples with larger tensile strength,
the mist results in improved binding,
the mist does not condense in the sample frame,
the mist provides an even distribution of the moisture in the web, and
the generation of mist with ultrasound is energy efficient.

### INDUSTRIAL APPLICABILITY

The product of the present invention, or the product prepared using the method of the present invention is useful in replacing conventional insulation or cushioning materials.

Particularly, the product can be used for thermal or acoustic insulation materials or for packaging, or in preparing filtering or absorbing materials.

### CITATION LIST

### Patent Literature

WO 2006107847 A1

### Non Patent Literature

Hjelt T., Ketoja J. A., Kiiskinen H., Koponen A. I., Pääkkönen E. (2022) Foam forming of fiber products: a review, Journal of Dispersion Science and Technology, 43:10, 1462-149

1. A process for preparing a renewable fiber product from a fibrous raw material, wherein the process comprises:
depositing a fibrous raw material comprising a renewable fiber material in a content of 95-100 w-%, calculated from the solids of the raw material, into a fiber web using gas-assisted dry-forming,
moistening the raw material to a selected moisture content in the range of 10-70 w-%, before, during or after the dry-forming, to form a moistened fiber web, and
drying the moistened fiber web to form a dry-formed fiber product.

2. The process of claim 1, wherein the renewable fiber material is obtained from cellulose fibers.

3. The process of claim 1, wherein at least 80 w-% of the fibrous raw material has an average fiber length of <3.5 mm.

4. The process of claim 1, wherein binder is added to the fibrous raw material, wherein the binder is selected from the group consisting of starch, rosin compounds, Alkyl Ketene Dimer (AKD), Alkenyl Succinic Anhydride (ASA), polyamide-amine-epichlorohydrin (PAE), poly-(D)-glucosamine or poly(vinyl alcohol) (PVOH), and binding fibers, and wherein the binder is added as a spray or a foam, into a content of less than 5 wt-%.

5. The process of claim 1, wherein a temperature of 20-105° C. is used in the dry-forming step.

6. The process of claim 1, wherein the fiber web is provided with a moisture content of 30-70%.

7. The process of claim 1, wherein the fiber web is moistened after the deposition, whereby the moistening step is separate from the dry-forming step.

8. The process of claim 1, wherein the fiber web is moistened to a level that will provide a target strength on a level of >1.5 Nm/g for the tensile index, or alternatively >20 kPa for the compression stress.

9. The process of claim 1, wherein the web is compacted before or during the drying step by continuing the drying, or by compressing, until a desired density is achieved.

10. The process of claim 1, wherein the web is compacted before or during the drying step, while not causing a significant reduction in the porosity of the web.

11. The process of claim 1, wherein the drying step is carried out as a thermal drying selected from the group consisting of non-contact drying, microwave drying, radiofrequency drying, air drying, infrared drying, cylinder drying or by using superheated steam, or any combination of these.

12. The process of claim 1, wherein the fiber product has a density of 20-100 kg/m³.

13. The process of claim 1, wherein fiber product has a density of 450-700 kg/m³.

14. A dry-formed fiber product, wherein the product is prepared by the process of claim 1.

15. The dry-formed fiber product of claim 14, wherein the product is formed of 100% renewable fiber raw materials, calculated from the weight of the raw materials, or alternatively containing less than 5 wt-% thermoplastic or thermoset polymer, calculated from the solid matter of the formed raw material mixture.

16. The process of claim 1, further comprising utilizing the dry-formed fiber product, in insulation or cushioning materials or in filtering or absorbing materials.

17. The process of claim 1, wherein the dry-formed fiber product contains pores having an average pore diameter of 100-280 μm.

18. The process of claim 1, wherein the moistening takes place by spraying, misting, or steaming.

19. The process of claim 1, wherein the process does not utilize synthetic or fossil-based binding agents.
